(19) United States
(12) Patent Application Publication
(10) Pub. No.: US 2006/0239239 A1
(43) Pub. Date: Oct. 26, 2006

(54) Random access method for wireless communication systems

(75) Inventor: Weidong Yang, Schaumburg, IL (US)

Correspondence Address: Howard Chen, Esq.;PRESTON GATES & ELLIS LLP, Suite 1700, 55 Second Street, San Francisco, CA, 94105, US

(73) Assignee: Navini Networks, Inc.

(21) Appl. No.: 11/394,507

(22) Filed: Mar. 31, 2006

Related U.S. Application Data
(60) Provisional application No. 60/674,777, filed on Apr. 26, 2005.

(51) Int. Cl. H04B 7/216

(52) U.S. Cl. 370/342

(57) ABSTRACT

A method is disclosed for establishing wireless random access communications between a base station and multiple mobile terminals. The base station first configures one or more uplink random access opportunities based on predetermined time and frequency variables, and then broadcasts the opportunities. The base station keeps monitoring the uplink random access opportunities so that a random access request made by a mobile terminal using one of the broadcasted opportunities can be detected. Upon receiving the random access request, the base station broadcasts downlink access channels so that a mobile terminal can distinguish which downlink access channel is intended for itself.

### CROSS REFERENCE

This application claims the benefits of U.S. Patent Application Ser. No. 60/674,777, which was filed on Apr. 26, 2005.

### BACKGROUND

The present invention relates generally to wireless communication systems, and more particularly, to random access method.

In a wireless communication network, random access is a base station dynamically assigns radio resources to a large set of mobile terminals, each with relatively bursty traffic. In uplink random access, a mobile terminal sends normally a preamble and a message to the base station, and the base station can identify the preamble through correlation methods. With information provided by the preamble, the base station can subsequently properly detect the message. But before sending the preamble and message, an initial ranging procedure is also necessary, by which a mobile terminal adjusts the uplink transmission timing and power so that uplink signals from different mobile terminals arrive at the base station synchronized and with the same power.

In IS-95, the message in the uplink transmission is modulated with an orthogonal modulation (Hadamard transform) and sent without a pilot. In CDMA2000, the uplink pilot is introduced so that coherent detection can be performed for the uplink transmission.

In WCDMA, a random access request comprises of a preamble and a message packet. The pilot, and more generally the control channel, is I-Q multiplexed with the message packet.

In IEEE 802.16's OFDMA mode, the ranging request consists of a pseudo-random sequence. Actually the pseudo-random sequences needed for initial ranging, periodic ranging and bandwidth requests are all drawn from a pool of 256 pseudo-random sequences, which are generated with a linear shift register. Normally m1 sequences are reserved for initial ranging, m2 sequences are reserved for periodic ranging, m3 sequences are reserved for bandwidth request, where m1, m2 and m3 are some positive integers with m1+m2+m3<=256.

In a ranging or random access process, the mobile terminal can increase the transmission power of a ranging or random access attempt if a previous attempt fails to elicit a response from a base station. Yet there are some limitations to the maximum transmission power the mobile terminal can use. One such limitation is a maximum transmission power a mobile terminal can supply, another is multi-cell interference that the ranging or random access attempt can generate at other cells. So it is preferred that ranging or random access can succeed at a relatively low transmission power level.

Interference among preambles from various random access attempts is a problem for IS-95, CDMA2000 and WCDMA. The pilot and the message packet of one random access attempt can also be polluted by multiple access interference from other random access attempts. In IEEE 802.16-2004, the multiple access interference for the ranging sequences can also be severe as the cross-correlation properties of those ranging sequences which may not be good, especially when there are timing offsets among the sent ranging sequences.

### SUMMARY

In view of the foregoing, a method is disclosed for establishing wireless random access communications between a base station and multiple mobile terminals. The base station first configures one or more uplink random access opportunities based on predetermined time and frequency variables, and then broadcasts the opportunities. The base station keeps monitoring the uplink random access opportunities so that a random access request made by a mobile terminal using one of the broadcasted opportunities can be detected. Upon receiving the random access request, the base station broadcasts downlink access channels so that a mobile terminal can distinguish which downlink access channel is intended for itself.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates a wireless network with a base station and multiple mobile terminals making random access requests.

FIG. 2 shows components of a random access request.

FIG. 3 illustrates multiple mobile terminals taking up various random access opportunities.

FIG. 4 illustrates multiple mobile terminals occupying the same random access opportunity choosing different modulation sequences.

### DESCRIPTION

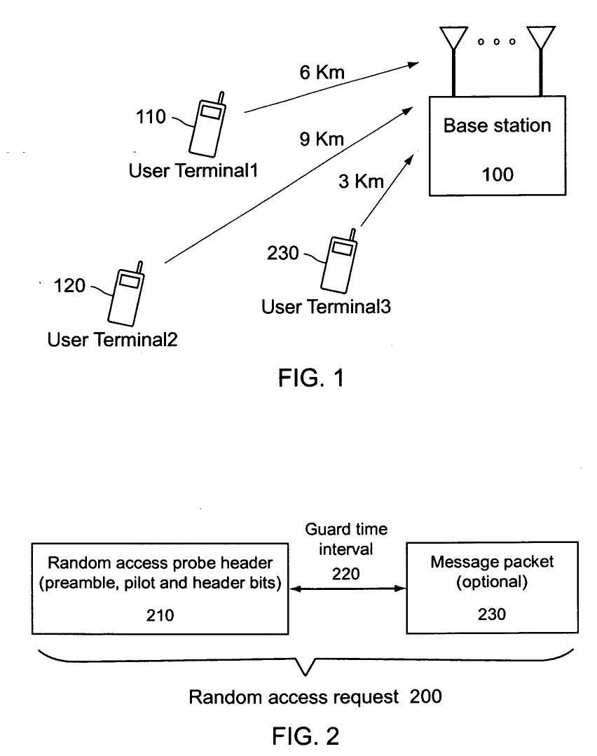

FIG. 1 illustrates a wireless network with a base station 100 and three mobile terminals 110, 120 and 130 making random access requests to the base station. The distance between a mobile terminal and the base station 100 is different for each mobile terminal, and they are 6 km, 9 km and 3 km for the mobile terminal1 110, terminal2 120 and terminal3 130, respectively in the example. As the signals travel at the speed of light, they arrive at the base station 100 with different delays, which are assumed to be 20 us, 30 us and 10 us for mobile terminal1 110, terminal2 120 and terminal3 130, respectively.

FIG. 2 shows components of a random access request 200. In general, the random access request 200 has three parts. The first part is a random access probe header 210, which includes a preamble, a pilot and header bits. The preamble alerts the base station the existence of a random access request 200. The pilot helps the base station to estimate the wireless channel response. The header bits, as information bearing symbols, contain the most critical information, and can be any or all of the followings: (1) signifying the identification of the mobile terminal, (2) signifying a temporary identification of the mobile terminal so that a base station can use it as reference when acknowledging the random access request, (3) signifying the length, spreading codes, and coding and modulation scheme for a message packet appended to the random access request, or (4) including a cyclic redundancy check (CRC) of the information bits to check its integrity. In this case, multiple mobile terminals may choose to use the same spreading codes to send the message packets. Also in this case, the mobile terminals are employing spatial division multiple access (SDMA) to access the base station. The spatial signatures of these mobile terminals can be determined from the transmitted sequence C (described in subsequent paragraphs) from different mobile terminals. It is relatively easy for the base station to separate signals coming from different mobile terminals if they happen to use the same spreading code for their trailing message packets. The header bits may also be protected by a channel-coding scheme.

Referring to FIG. 2, a second part in the random access request 200 is shown to be a guard time interval 220, which separates the random access probe header 210 from the trailing message packet 230. The third part of the random access request 200 is an optional message packet 230, which can be spread by the spreading code contained in the probe header 210.

To reduce the potential interference and achieve privacy among the multiple random access requests, a spread-spectrum technique is used, which structures signals by employing modulation sequence, frequency hopping or a hybrid of these. Spread spectrum generally makes use of a sequential noise-like signal structure to spread the normally narrowband information signal over a relatively wide band of frequencies. The base station 100 correlates the received signals to retrieve the original information signal. Following is an exemplary modulation sequence construction.

Starting with a first code sequence A, which is a sequence of length 64, each element of A is a complex number with an absolute value of 1. A second code sequence B is a sequence obtained by performing Inverse Discrete Fourier Transform (IDFT) on A, so the length of B is also 64, i.e., [b1 b2 . . . b63 b64].

It can be verified that the circular autocorrelation of sequence B is a delta function, i.e., the autocorrelation of sequence B is 64 at time shift 0, and 0 at all other time shift. In this sense, the sequence B at the transmitter side (e.g., the mobile terminal) and the sequence B[−n] at the receiver side (e.g., the base station) “cancels” each other out.

Suppose on the transmitter side, another sequence M of length 64, which is zero at every index except that m1=100, m11=I1, m12=I2, m13=I3, m14=I4, where I1, I2, I3 and I4 are information bearing quadra-phase-shift keying (QPSK) symbols, is circular convoluted with sequence B, so the resulting sequence C of length 64 is generated. Then the transmitter sends out [c61 c62 c63 c64 c1 c2 c3 . . . c62 c63 c64 c1 c2 c3 c4]. It is understood that the circular convolution of any length 64 subsequence of C with B[−n] (the conjugate and time-reverse of sequence B, i.e. [b*(64) b*(63) . . . b*(2) b*(1)]) will produce a circular shifted version of sequence M.

When sequence C is transmitted through a wireless channel, the wireless channel processes the transmitted sequence C by applying a convolution to it. So the circular convolution of B[−n] and a length 64 subsequence of the received sequence will produce a sequence which is the circular convolution of the wireless channel and sequence M. As long as the wireless channel duration is less than 10, m1 can bring out the wireless channel response. With the knowledge of the wireless channel response, now the information bearing QPSK symbols I1, I2, I3 and I4 can be estimated. Of course, channel-coding scheme can be beneficially used for the information bearing symbols, as long as it is agreed upon on both mobile terminal and base station sides.

According to one embodiment of the present invention, the aforementioned modulation sequence is used for random access preamble, pilot and request header. According to another embodiment of the present invention, the modulation sequence is used for random access preamble and random access header only.

As the transmissions from mobile terminals are not scheduled or coordinated, collisions can happen. There are two ways, as embodiments of the present invention, to reduce the collision probability. The first approach is for the base station to configure and broadcast multiple random access opportunities for the uplink random access, and each mobile terminal can randomly choose one of the opportunities for its uplink transmission. According to the second approach, the base station broadcasts a prototype modulation sequence, a mobile terminal can choose randomly a time-shifted version of the prototype modulation sequence as its own modulation sequence for its uplink transmission.

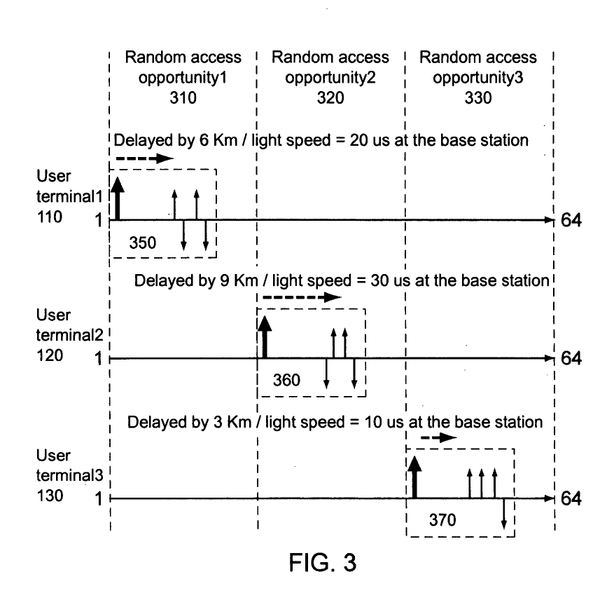

FIG. 3 illustrates a timing diagram for showing random access opportunities provided by the base station and captured by various mobile terminals in accordance with one embodiment of the present invention. Refer to both FIGS. 1 and 3, the base station 100 configures three random access opportunities 310, 320 and 330 by using time and frequency as two configuring variables. In this case, if signal 350 from mobile terminals 110 arrives at the base station 100 with a 20 us delay, it may choose random access opportunity1 310. Similarly, if signal 360 from mobile terminal2 120 arrives at the base station 100 with a 30 us delay, it may choose random access opportunity2 320. Signal 370 from terminal3 130 arriving at the base station 100 with a 10 us delay may choose another random access opportunity3 330. By taking different random access opportunities, the uplink communications between the base station 100 and the mobile terminals 110, 120 and 130 can avoid collisions. As long as the durations of the random access opportunities are long enough, the received signal will still be confined within a random access opportunity no matter what the distance is from a mobile terminal to the base station.

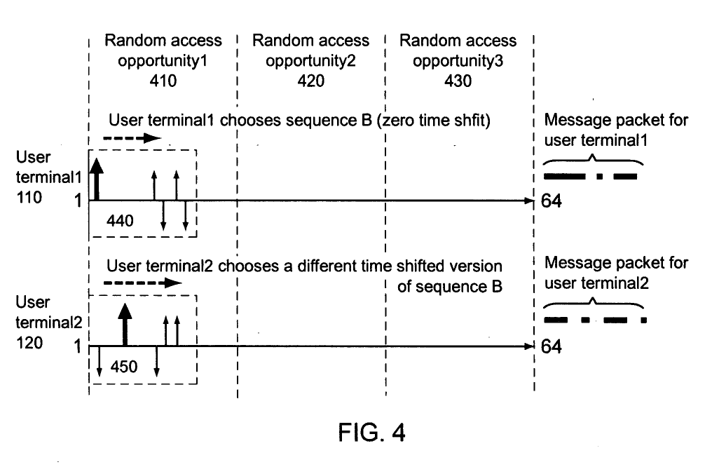

FIG. 4 illustrates an arrangement for sharing a random access opportunity by multiple mobile terminals according to another embodiment of the present invention. In this example, when two mobile terminals 110 and 120 are allowed to choose the same random access opportunity1 410, in order to avoid collision, the mobile terminals 110 and 120 can choose different modulation sequences. A signal 440 from mobile terminal1 110 is modulated by a prototype modulation sequence (zero time shifted), and a signal 450 from mobile terminal2 120 is modulated by a different time shifted version of the prototype modulation sequence, which may be chosen randomly. At the base station 100, after performing cyclic correlation with B[−n] on the received signals 440 and 450, it will see two spikes or peaks (the preambles for two requests) in the correlation result in the frequency domain. By detecting two spikes, the base station 100 knows there are two mobile terminals sending random access requests at the same time through the same random access opportunity. From these two spikes (i.e., the preambles), the base station can estimate the spatial signatures of those two mobile terminals, and can find the contents of the random access headers through uplink nulling, beamforming or joint detection. Aided by the spatial signatures found in the preambles and under the direction of the random access headers, the base station can then extract information contained in the message packets.

As aforementioned, a mobile terminal has to choose a random access opportunity as well as a modulation sequence, and it may choose them completely at random. If two mobile terminals happen to choose the same random access opportunities and the same modulation sequence, then collision will occur and this particular random access request will fail. In this case, the mobile terminals may again randomly choose other access opportunities and modulation sequences to make further requests.

In a downlink access channel associated with the uplink random access opportunities, the base station sends down a location, i.e., time and frequency that the base station has detected a random access request. The base station can also include in the downlink access channel, information extracted from the random access header and/or message packet so that the identity of the mobile terminal, which is found to have sent the random access request, is made available. From the identity information the mobile terminal that have sent the corresponding random access request will know the information contained in the downlink access channel is directed to itself.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

What is claimed is:

1. A method for establishing random access communications between a base station and one or more mobile terminals, the method comprising:
configuring one or more uplink random access opportunities based on time and frequency variables;
broadcasting the uplink random access opportunities;
monitoring the uplink random access opportunities for detecting a random access request; and
providing one or more down link access channels to the mobile terminals making the random access requests,
wherein random access requests from multiple mobile terminals occupy different uplink random access opportunities or are modulated by different modulation sequences for reducing collision.

2. The method of claim 1 further comprising:
choosing an uplink random access opportunity by a mobile terminal;
choosing a modulation sequence by the mobile terminal;
modulating a random access request with preamble and request header with the modulation sequence by the mobile terminal; and
transmitting the modulated random access request to the base station by the mobile terminal.

3. The method of claim 2, wherein the random access request further includes a pilot.

4. The method of claim 1, wherein the providing further includes:
extracting identity information of the mobile terminal from the random access request; and
providing the downlink access channel to the mobile terminal associated with the identity information.

5. The method of claim 4, wherein the extracting further includes performing predetermined correlation on the received random access request signal.

6. The method of claim 5, wherein a cyclic correlation of received random access requests is performed to identify different peaks in a frequency domain corresponding to different preambles of the requests.

7. The method of claim 1, wherein the broadcasting further includes broadcasting a predetermined prototype modulation sequence based on which the modulation sequences are derived.

8. The method of claim 6, wherein the modulation sequences are time shifted versions of the prototype modulation sequence.

9. The method of claim 1, wherein two mobile terminals sharing the same random access opportunity have different modulation sequences.

10. A method for establishing random access communications between a base station and one or more mobile terminals, the method comprising:
configuring one or more uplink random access opportunities based on time and frequency variables;
broadcasting the uplink random access opportunities;
monitoring the uplink random access opportunities chosen by one or more mobile terminals for detecting a random access request therefrom; and
providing one or more down link access channels to the mobile terminals making the random access requests,
wherein random access requests from multiple mobile terminals occupy different uplink random access opportunities for reducing collision.

11. The method of claim 10 further comprising:
choosing an uplink random access opportunity by a mobile terminal;
choosing a modulation sequence by the mobile terminal;
modulating a random access request with preamble and request header with the modulation sequence by the mobile terminal; and
transmitting the modulated random access request to the base station by the mobile terminal.

12. The method of claim 11, wherein the random access request further includes a pilot.

13. The method of claim 10, wherein the providing further includes:
extracting identity information of the mobile terminal from the random access request; and
providing the downlink access channel to the mobile terminal associated with the identity information.

14. The method of claim 13, where the extracting further includes performing predetermined correlation on the received random access request signal.

15. A method for establishing random access communications between a base station and one or more mobile terminals, the method comprising:
configuring one or more uplink random access opportunities based on time and frequency variables;
broadcasting the uplink random access opportunities;
monitoring the uplink random access opportunities for detecting a random access request; and
providing one or more down link access channels to the mobile terminals making the random access requests,
wherein random access requests from multiple mobile terminals share the same random access opportunity but are modulated by different modulation sequences for reducing collision.

16. The method of claim 15 further comprising:
choosing an uplink random access opportunity by a mobile terminal;
choosing a modulation sequence by the mobile terminal;
modulating a random access request with preamble and request header with the modulation sequence by the mobile terminal; and
transmitting the modulated random access request to the base station by the mobile terminal.

17. The method of claim 16, wherein the random access request further includes a pilot.

18. The method of claim 15, wherein the providing further includes:
extracting identity information of the mobile terminal from the random access request; and
providing the downlink access channel to the mobile terminal associated with the identity information.

19. The method of claim 18, wherein the extracting further includes performing predetermined correlation on the received random access request signal.

20. The method of claim 19, wherein a cyclic correlation of received random access requests is performed to identify different peaks in a frequency domain corresponding to different preambles of the requests.

21. The method of claim 15, wherein the broadcasting further includes broadcasting a predetermined prototype modulation sequence based on which the modulation sequences are derived.

22. The method of claim 21, wherein the modulation sequences are time shifted versions of the prototype modulation sequence.
